(19) United States
(12) Patent Application Publication
(10) Pub. No.: US 2015/0135947 A1
(43) Pub. Date: May 21, 2015

(54) Systems and Methods for Managing Turbine Intake Filters

(71) Applicant: BHA Altair, LLC, Franklin, TN (US)

(72) Inventors: Paul Sherwood Bryant, Alton (GB); Michelle Fullerton Simpson, Simpsonville, SC (US)

(21) Appl. No.: 14/082,926

(22) Filed: Nov. 18, 2013

(51) Int. Cl. F02C 7/057; F02C 7/05

(52) U.S. Cl. CPC F02C 7/057; F02C 7/05
USPC 95/1; 95/273; 95/286; 700/282

(57) ABSTRACT

Certain embodiments herein relate to systems and methods for managing turbine intake filters. In one embodiment, a system can include at least one memory configured to store computer-executable instructions and at least one control device configured to access the at least one memory and execute the computer-executable instructions. The instructions may be configured to receive information associated with a filter and identify the filter based at least in part on the information received. The instructions may be further configured to pulse the filter based at least in part on the information received.

### FIELD OF THE DISCLOSURE

Embodiments of the disclosure generally relate to managing turbine intake filters and, more particularly, to systems and methods for managing turbine intake filters.

### BACKGROUND

Air entering gas turbine intakes pass through filters to remove impurities from the air. There are many different types and brands of intake filters and the many different filters can age and clean air differently from each other as well as other filters. Additionally, many different types of filters can be used within a single turbine intake system. Information about each filter may not be currently available nor accessible in existing systems, which can affect management of a turbine intake system.

### BRIEF SUMMARY OF THE DISCLOSURE

Some or all of the above needs and/or problems may be addressed by certain embodiments of the disclosure. Certain embodiments may include systems and methods for managing turbine intake filters. According to one embodiment of the disclosure, there is disclosed a system. The system may include at least one filter associated with a turbine intake. The system may also include a communication device associated with the filter and operable to transmit information about the filter. The information may be received by a device of the system, and the information may be operable to identify the filter.

According to another embodiment of the disclosure, there is disclosed a method. The method may include filtering at least one turbine intake using at least one filter. The method can also include communicating, by a communication device associated with the at least one filter, information associated with the at least one filter. Further, the method can include receiving, by a control device associated with at least one turbine intake, the information associated with the at least one filter. The method may further include pulsing the at least one filter based at least in part on the information received.

According to another embodiment of the disclosure, there is disclosed a system. The system may include at least one memory configured to store computer-executable instructions and at least one control device configured to access the at least one memory and execute the computer-executable instructions. The instructions may be configured to receive information associated with at least one turbine intake filter. The information may be operable to identify the filter. The system may use the information to clean and/or replace the filter.

Other embodiments, systems, methods, aspects, and features of the disclosure will become apparent to those skilled in the art from the following detailed description, the accompanying drawings, and the appended claims.

### BRIEF DESCRIPTION OF THE DRAWINGS

The detailed description is set forth with reference to the accompanying drawings, which are not necessarily drawn to scale. The use of the same reference numbers in different figures indicates similar or identical items.

FIG. 1 illustrates an example system for managing turbine intake filters, according to an embodiment of the disclosure.

FIG. 2 is a flow diagram of an example method for managing turbine intake filters based at least in part on communicating filter information, according to an embodiment of the disclosure.

FIG. 3 illustrates an example functional block diagram representing an example intake filter management system, according to an embodiment of the disclosure.

### DETAILED DESCRIPTION

Illustrative embodiments of the disclosure will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so this disclosure will satisfy applicable legal requirements.

Certain embodiments disclosed herein relate to managing turbine intake filters. Accordingly, a system can be provided to manage turbine intake filters. For example, an intake may be filtered with at least one filter. There may be a communication device associated with the filter, the communication device operable to communicate information associated with the filter. The information may be received by a control device, and in some embodiments the communication device may comprise a control device, associated with the filter. In a further embodiment, a task may be implemented based at least in part on the information associated with the filter received by the communication device. One or more technical effects associated with certain embodiments herein may include, but are not limited to, identification of filters in a turbine intake system, and identification of management tasks executed based at least in part on information about the filters. Furthermore, one or more technical effects associated with certain embodiments can include increasing the life of individual filters and increasing efficiency of filter cleaning and replacement.

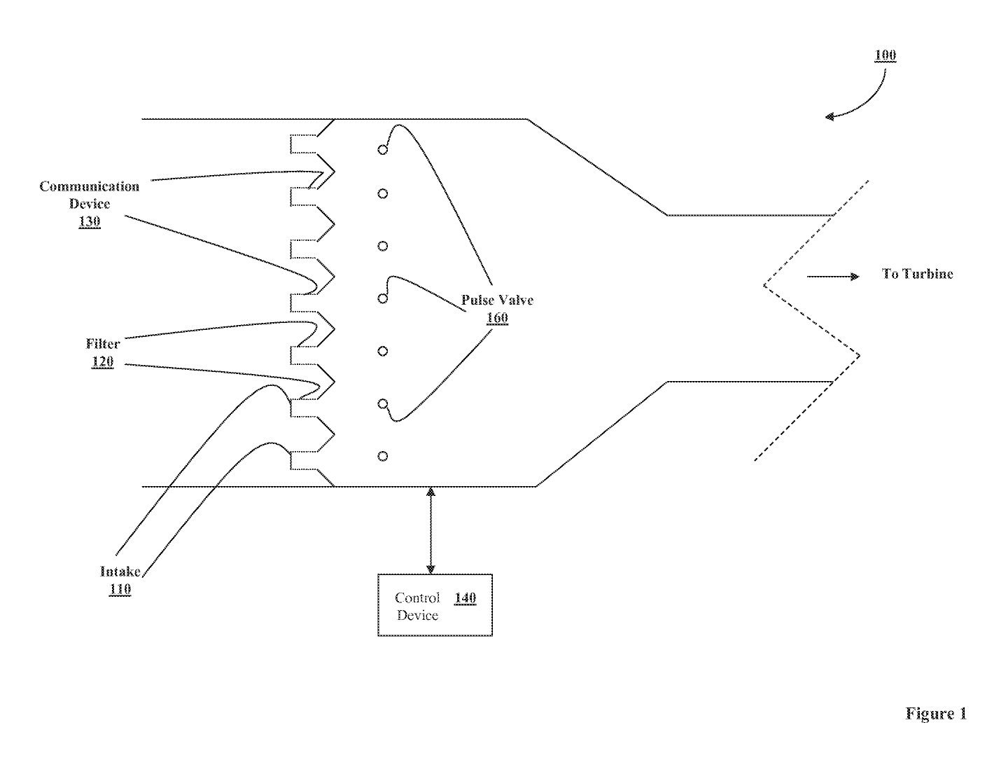

FIG. 1 depicts an example system 100 that facilitates managing turbine intake filters. According to an embodiment of the disclosure, the system 100 may include at least one intake 110 through which air may pass into a turbine. Each intake 110 may be associated with at least one filter 120. Each filter 120 may be associated with a respective communication device 130, and each communication device 130 may be operable to communicate information associated with the respective filter 120. A control device 140 may be operable to receive information about each filter 120 from the respective communication device 130. Based at least in part on the information received, the control device 140 may further be operable to direct a respective pulse valve 160 to pulse the respective filter 120.

With continued reference to FIG. 1, in one embodiment of the disclosure, each filter 120 may be operable to clean and/or remove impurities from air passing through the filter 120. The filters 120 may be of varying type, size, and performance characteristics, and many different filters can be used in any single turbine intake system, such as 100. Depending on the characteristics of each filter 120, air may be cleaned by the filters 120 at different levels of efficiency. For example, different filters may have different pulsing parameters. Information about each filter 120 may include the particular characteristics of the filter 120, and the information may be communicated by the respective communication device 130 associated with the filter 120. Each communication device 130 may be in proximity with the respective filter 120 or it may be embedded or a part of the filter 120. Each communication device 130 may be operable to communicate information, including communication via radio frequency identification. The information may include, among other things, the type and size of the filter 120, the date of installation of the filter 120 in the at least one intake 110, and filter performance characteristics. The information may further include other data such as the number of pulses the filter 120 has received from the pulse valve 160, the strength of the pulses, and the type of pulses. The information associated with a filter 120 may be used, at least in part, by the control device 140 to facilitate execution of a management task of the turbine intake system 100. Management tasks may include pulsing a filter 120, and the task may include replacement of the filter 120, among other management tasks. Pulsing a filter 120 may include cleaning and/or causing air to pass through the filter 120, for example, causing air to pass through the filter in the opposite direction of air entering through the at least one intake 110. The management tasks may be executed based at least in part on the information received which may include the particular type, strength, and/or number of pulses, according to what the particular filter 120 may be capable of receiving. The control device 140 may also direct operation of a respective pulse valve 160 based at least in part on not receiving information about a filter 120, for example, based at least in part on default pulsing parameters. The control device 140 may further be operable to manipulate more than one pulse valve 160. The pulse valves 160 may be operable to direct air to one or more respective filters 120, based at least in part on information received by the control device 140 from the respective communication device 130. The information received may be associated with an individual filter 120 or with more than one filter 120. Each pulse valve 160 may then be directed to pulse the individual filter 120 or a group of filters 120, including by using a uniform set of pulse characteristics for the group. The parameters of the group of filters 120 may be designated at the time of installation of the filters 120, at the time of installation of the system, and/or dynamically configurable in real-time.

As desired, embodiments of the disclosure may include a system 100 with more or fewer components than are illustrated in FIG. 1. Additionally, certain components of the system 100 may be combined in various embodiments of the disclosure. The system 100 of FIG. 1 is provided by way of example only.

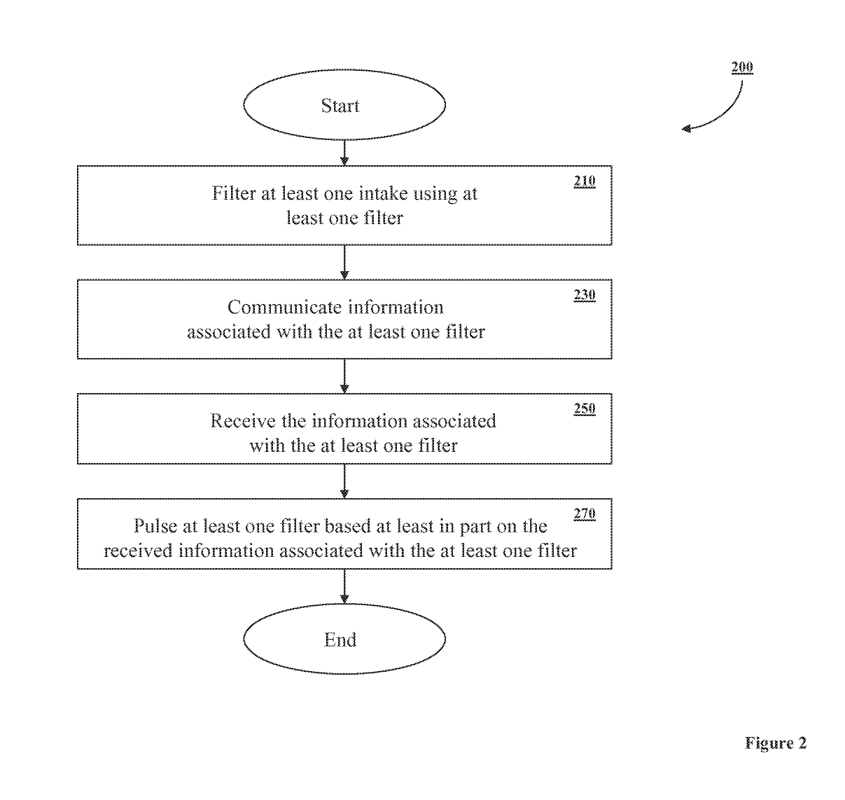

Referring now to FIG. 2, shown is a flow diagram of an example method 200 for managing turbine intake filters, according to an illustrative embodiment of the disclosure. The method 200 may be utilized in association with various systems, such as the system 100 illustrated in FIG. 1.

The method 200 may begin at block 210. At block 210, at least one filter, such as 120, may be associated with at least one intake, such as 110. The filter may be of varying type and size, and with varying filtration performance characteristics, and may be operable to clean and/or remove impurities from air flowing through the intake. There may be a plurality of filters associated with an intake and a plurality of filters associated with a plurality of intakes. The filter may further be associated with a communication device.

Next, at block 230, information about the filter may be communicated by a device associated with the filter. The communication device may be like the communication device 130 of FIG. 1, and the communication may include radio frequency identification, wireless communication, infrared communication, or any other suitable mode of communication. The communication device may be in proximity with the filter and it may be embedded in the filter. The information may include filter type, size, and performance characteristics, as well as strength, number, and type of pulses, among other things.

Next, at block 250, the method 200 can include receiving the information associated with the filter. The information may include parameters such as are described in block 230. The information may be received by a control device, such as control device 140 of FIG. 1. The control device may be operable to receive communication via radio frequency identification, wireless communication, infrared communication, or any other suitable mode of communication. The control device may further be operable to receive information from a plurality of communication devices, including information associated with a plurality of filters, and information associated with one or more turbine intake systems.

Based at least in part on the information received, the method 200 may facilitate execution of a management task. The management task may comprise pulsing the filter and/or replacing the filter. The method 200 may pulse at least one filter based at least in part on the information received. The information may include characteristics about the filter, including what type, strength, and number of pulses the filter is operable to receive. The pulse parameters may then be configured particular to the type and size of the particular filter, and with the filter's particular age and performance characteristics. The pulse may also be configured based at least in part on information received that may include characteristics of a group of filters, and the group may include homogeneous characteristics. In some embodiments of the method, a filter may be replaced instead of or in addition to being pulsed. In further embodiments, the filter may be pulsed, not pulsed, and replaced based at least in part on no information about the filter being received.

The method 200 of FIG. 2 may optionally end following block 270.

The operations described and shown in the method 200 of FIG. 2 may be carried out or performed in any suitable order as desired in various embodiments of the disclosure, and the method 200 may repeat any number of times. Additionally, in certain embodiments, at least a portion of the operations may be carried out in parallel. Furthermore, in certain embodiments, fewer than or more than the operations described in FIG. 2 may be performed.

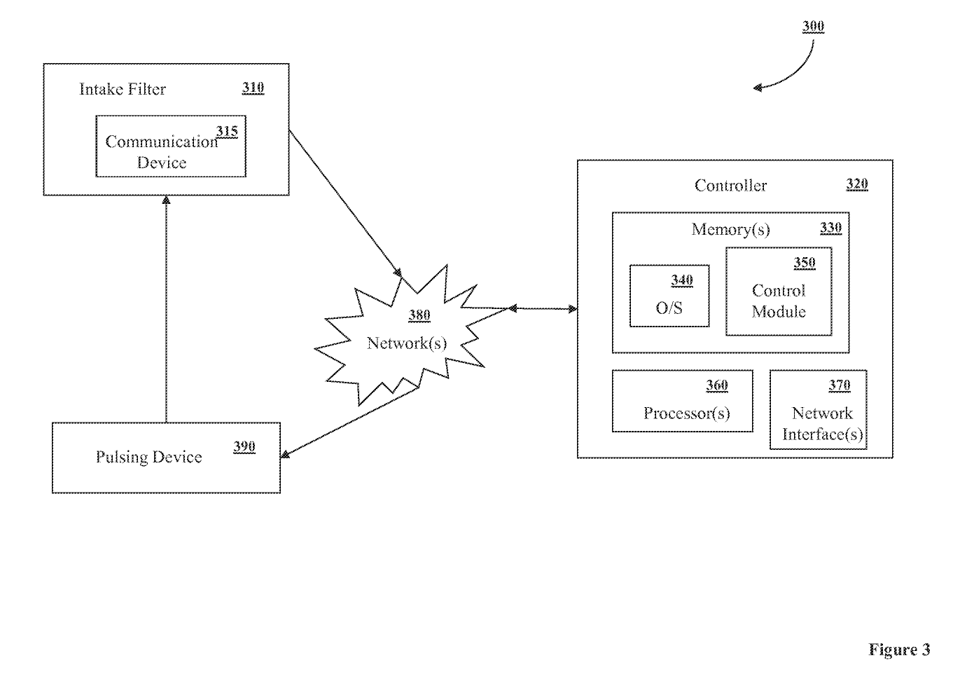

FIG. 3 depicts a block diagram of one example system 300 that facilitates managing turbine intake filters. According to an embodiment of the disclosure, the system 300 may include a control module 350 associated with a controller 320. The control module 350 may be configured to receive information about at least one intake filter 310 from a communication device 315 associated with the intake filter 310. In some embodiments of the system 300, the communication device 315 may be embedded in the intake filter 310. The control module 350 may be able to identify the intake filter 310 based at least in part on the information received. The control module 350 may further be operable to facilitate the execution of a management task, based at least in part on the information received, and based at least in part on not receiving information associated with an intake filter 310. In some embodiments, the management task may include manipulation of at least one pulsing device 390 to pulse the at least one intake filter 310, and replacement of the at least one intake filter 310, among other categories of management tasks.

The controller 320 may include any number of suitable computer processing components that may, among other things, facilitate the management of turbine intake filters. Examples of suitable processing devices that may be incorporated into the controller 320 include, but are not limited to, personal computers, tablet computers, wearable computers, personal digital assistants, mobile phones, application-specific circuits, microcontrollers, minicomputers, other computing devices, and the like. As such, the controller 320 may include any number of processors 360 that facilitate the execution of computer-readable instructions. By executing computer-readable instructions, the controller 320 may include or form a special purpose computer or particular machine that facilitates processing of intake filter management.

In addition to one or more processors 360, the controller 320 may include one or more memory devices 330, and/or one or more communications and/or network interfaces 370. The one or more memories 330 may include any suitable memory devices, for example, caches, read-only memory devices, random access memory devices, magnetic storage devices, etc. The one or more memories 330 may store filter and pulsing device data, executable instructions, and/or various program modules utilized by the controller 320, for example, at least one control module 350 and an operating system (“O/S”) 340. The one or more memories 330 may include any suitable data and applications that facilitate the operation of the controller 320 including, but not limited to, for communication between the controller 320, network 380, pulsing device 390, and intake filter 310. In certain embodiments, the one or more memories 330 may be further operable to store a history of received information and/or pulse valve information associated with at least one intake filter 310. The 0/S 340 may include executable instructions and/or program modules that facilitate and/or control the general operation of the controller 320.

Additionally, the O/S 340 may facilitate the execution of other software programs and/or program modules by the processor(s) 360, such as, the control module 350. The control module 350 may be a suitable software module with corresponding hardware capability configured to allow communication with objects outside the controller 320. The control module 350 may include one or more programming modules to facilitate management of turbine intake filters. For example, the control module 350 may communicate with the intake filter 310 and pulsing device 390 via network interface 370 and network 380. The control module 350 may be further operable to facilitate manipulation of the pulsing device 390 based at least in part on information received by the communication device 315. The control module 350 may provide pulsing parameters particular to the intake filter 310 based at least in part on the information received about that intake filter 310. The pulsing device 390 may be associated with at least one intake filter 310 and may pulse the filter 310 by cleaning or by causing air to travel through the filter 310, for example, by causing air to travel through the filter 310 in the opposite direction of the intake air. The pulsing device 390 may use varying types, strengths, and amounts of pulses for an intake filter 310, according to the filter type, size, and age. The control module 350 may therefore customize manipulation of the pulsing device 390 particular to parameters of intake filter 310 such as filter type, size, age, and performance factors, as well as a history of pulses to that intake filter 310 including number of pulses, and strength and type of the pulses. The control module 350 may be further operable to facilitate the manipulation of a plurality of pulsing devices 390 based at least in part on receiving information associated with an individual intake filter 310 and/or associated with a group of filters.

With continued reference to FIG. 3, in some embodiments of the system 300, the communication device 315 may be further operable to receive and store information. In some embodiments, the control module 350 may facilitate the writing of information to the communication device 315. For example, some items of information may include parameters of filters, such as the parameters of intake filter 310 mentioned above.

As desired, embodiments of the disclosure may include a system 300 with more or fewer components than are illustrated in FIG. 3. Additionally, certain components of the system 300 may be combined in various embodiments of the disclosure. The system 300 of FIG. 3 is provided by way of example only.

While the disclosure has been described in connection with what is presently considered to be the most practical and various embodiments, it is to be understood that the disclosure is not to be limited to the disclosed embodiments, but on the contrary, is intended to cover various modifications and equivalent arrangements included within the spirit and scope of the appended claims.

This written description uses examples to disclose the disclosure, including the best mode, and also to enable any person skilled in the art to practice the disclosure, including making and using any devices or systems and performing any incorporated methods. The patentable scope of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

These computer-executable program instructions may be loaded onto a general purpose computer, a special purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

1. A gas turbine intake filter system comprising:
at least one filter;
a communication device associated with the at least one filter, the communication device operable to communicate information associated with the at least one filter; and
a control device associated with the at least one filter, the control device operable to receive information from the communication device.

2. The system of claim 1, wherein the communication device further comprises a radio frequency identification device.

3. The system of claim 1, wherein the control device is further operable to facilitate execution of at least one management task, based at least in part on the received information associated with the at least one filter.

4. The system of claim 1, wherein the control device is further operable to manipulate a plurality of pulse valves, wherein pulse air is directed to a plurality of filters based on at least one of (i) received information associated with an individual filter or (ii) received information associated with a group of filters.

5. The system of claim 1, wherein the communication device is embedded in the at least one filter.

6. The system of claim 1, wherein the received information associated with the at least one filter comprises at least one of: filter type, filter size, filter age, number of pulses, strength of pulses, filtration performance, and type of pulses.

7. A method comprising:
filtering at least one turbine intake using at least one filter;
communicating, by a communication device associated with the at least one filter, information associated with the at least one filter; and
receiving, by a control device associated with at least one turbine intake, the information associated with the at least one filter.

8. The method of claim 7, further comprising executing, based at least in part on the received information, at least one management task.

9. The method of claim 7, further comprising filtering a plurality of turbine intakes based at least in part on a plurality of filters.

10. The method of claim 7, further comprising pulsing a plurality of filters, wherein the pulsing is based on at least one of (i) received information associated with an individual filter or (ii) received information associated with a group of filters.

11. The method of claim 7, wherein the communication device is embedded in the at least one filter.

12. The method of claim 7, further comprising communicating at least one of: filter type, filter size, filter age, number of pulses, strength of pulses, filtration performance information, and type of pulses.

13. A system of managing gas turbine intake filters, the system comprising:
at least one processor; and
at least one memory storing computer-executable instructions, wherein the at least one processor is operable to access the at least one memory and execute the computer-executable instructions to:
receive information associated with at least one filter, wherein the information is communicated from a device associated with the at least one filter; and
identify the at least one filter based at least in part on the received information.

14. The system of claim 13, wherein the at least one memory further comprises a history of received information and pulses associated with the at least one filter.

15. The system of claim 13, wherein the computer-executable instructions are further operable to facilitate execution of at least one management task, based at least in part on the received information associated with the at least one filter.

16. The system of claim 13, wherein the computer-executable instructions are further operable to receive information from a device embedded in the at least one filter.

17. The system of claim 13, wherein the computer-executable instructions are further operable to write information to the communication device.

18. The system of claim 13, wherein the computer-executable instructions are further operable to receive at least one of: filter type, filter size, filter age, number of pulses, strength of pulses, filtration performance, and type of pulses.

19. The system of claim 13, wherein the computer-executable instructions are further operable to manipulate a plurality of pulse valves based on at least one of (i) received information associated with an individual filter or (ii) received information associated with a group of filters.

20. The system of claim 13, wherein the computer-executable instructions are further operable to facilitate execution of a turbine management task based at least in part on whether information associated with the at least one filter is received.
